(19) United States
(12) Patent Application Publication
(10) Pub. No.: US 2008/0059029 A1
(43) Pub. Date: Mar. 6, 2008

(54) METHOD OF DISCRIMINATING BETWEEN ROTATING WHEELS AND NONROTATING WHEELS OF A VEHICLE WHILE SAID VEHICLE IS BEING DRIVEN

(75) Inventor: Olivier COSTES, Cugnaux (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, TOULOUSE CEDEX 1 (FR)

(21) Appl. No.: 11/845,129

(22) Filed: Aug. 27, 2007

(30) Foreign Application Priority Data
Aug. 29, 2006 (FR) 06/07577

(51) Int. Cl. G06F 19/00

(52) U.S. Cl. 701/49

(57) ABSTRACT

The invention relates to a method of discriminating, while a vehicle (1) is being driven, between the rotating wheels (2-5) and the nonrotating wheels (15) of said vehicle, each wheel being fitted with an electronic module (6-9, 16), said method consisting in transmitting identification request signals to the electronic modules (6-9, 16) and in commanding, in response, the transmission, by each of said electronic modules, of a signal that includes a parameter identifying said module. According to the invention, this method furthermore consists, upon reception of identification request signals by an electronic module (6-9, 16), in calculating the level of reception of said identification request signals and in declaring the corresponding wheel to be a rotating wheel if said level of reception is between 10% and 90%.

The invention relates to a method of discriminating between rotating wheels and nonrotating wheels of a vehicle while said vehicle is being driven, each wheel being fitted with an electronic module designed to transmit signals representative of operating parameters of said wheel to a central processing unit mounted on the vehicle.

Increasingly, motor vehicles are being provided with parameter monitoring and/or measuring systems comprising sensors mounted on said vehicles.

As an example relating to such systems, mention may be made of monitoring systems comprising sensors mounted on each of the wheels of a vehicle, these being dedicated to the measurement of parameters, such as the pressure and/or temperature of the tires with which these wheels are fitted, and intended to inform the driver of any abnormal variation in the measured parameter.

These monitoring systems conventionally comprise:
mounted on each of the wheels of the vehicle, an electronic module incorporating the measurement sensors, a microprocessor and a radiofrequency transmitter; and
mounted on the vehicle, a central processing unit for receiving the signals transmitted by the electronic modules, which unit is provided with a calculator incorporating a radiofrequency receiver connected to an antenna.

One of the problems that such monitoring systems require to be solved lies in the necessity of having to associate, with each signal received by the receiver of the central processing unit, an information item relating to the location of the electronic module and therefore of the wheel from which this signal emanated, this necessity having to remain throughout the lifetime of the vehicle, that is to say having to be respected even after wheel changes or more simply inversions of the position of these wheels.

For these purposes, the monitoring systems must be designed so as to fulfill two functions consisting of:
a function usually called a “self-learning” function, intended for identifying the electronic modules of the wheels actually mounted on the vehicle; and
a location function intended to locate the position on the vehicle of the electronic modules identified.

At the present time, a conventional position location method consists in transmitting, by means of antennas mounted on the vehicle, LF (low frequency) signals, called identification request signals, to the electronic modules and in commanding, in response, the transmission, by each of said electronic modules, of an RF (high frequency) signal that includes a parameter for identifying said module to the central processing unit.

The main advantage of such a method lies in the fact that the position location procedure is very rapid and allows position location almost immediately after the vehicle is started.

The current usual “self-learning” method itself consists in fitting each electronic module with an acceleration sensor and in carrying out the “self-learning” function by implementing a correlation principle for correlating the values delivered by these acceleration and speed sensors of the vehicle.

The major problem with such a method lies in the fact that it requires a relatively long running time before reliable and exploitable information is delivered.

This is because, firstly, owing to the precision of the acceleration sensors, a minimum speed of around 20 km/h is required in order to obtain exploitable measurement values. Secondly, once this running threshold has been reached, a minimum running time is needed to confirm the correlation between wheel acceleration and vehicle speed.

For this reason, and despite the potentialities in terms of reactivity of wheel position location methods, the current monitoring systems are inoperative over a relatively long and variable lapse of time after a vehicle has been started.

The present invention aims to alleviate this drawback and to provide a method that allows a monitoring system to carry out the “self-learning” function right from the first revolutions of the wheels of a vehicle, without requiring a running speed threshold.

Another objective of the invention is to provide a method which is inexpensive to implement, as it requires only a simple software adaptation of current monitoring systems.

For this purpose, the subject of the invention is a method of discriminating, while a vehicle is being driven, between the rotating wheels arid the nonrotating wheels of said vehicle, each wheel being fitted with an electronic module designed to transmit signals representative of operating parameters of the wheel to a central processing unit mounted on the vehicle, said method consisting in transmitting signals, called identification request signals, to the electronic modules and in commanding, in response, the transmission, by each of said electronic modules, of a signal that includes a parameter for identifying each module to the central processing unit.

According to the invention, this method consists, upon reception of identification request signals by an electronic module, in calculating the level of reception of said identification request signals and in declaring that the corresponding wheel is rotating if said level of reception is between 10% and 90%.

The principle at the basis of the invention has therefore been to exploit the presence, during rotation of a wheel, of angular nonreception zones in which the identification request signals are not received by the electronic module fitted to this wheel, said nonreception zones being functions of the position of this electronic module relative to the antenna transmitting these signals.

On the basis of this principle, the invention consists in calculating the level of reception of the identification request signals and in associating:
a level of reception of between 10% and 90% with the electronic module being positioned in succession in nonreception zones and reception zones, and therefore associated with rotation of the wheel;
a level of reception of less than 10%, that is to say close to zero, with an unchanging position of the electronic module in a nonreception zone, and therefore associated with a nonrotating wheel; and
a level of reception of greater than 90%, i.e. close to 100%, with an unchanging position of the electronic module in a reception zone, and therefore associated with a nonrotating wheel.

Thanks to this discrimination, the invention therefore makes it possible for the wheels actually mounted on the vehicle (rotating wheels) to be very rapidly and precisely selected and for the other wheels on board the vehicle, such as spare wheel, set of unmounted wheels for winter driving, etc., to be disregarded during the position location procedure.

Consequently, the invention makes it possible to carry out the “self-learning function” right from the first revolutions of the wheels of a vehicle, without requiring a running speed threshold.

It should also be noted that the method according to the invention proves to be every effective from the economic standpoint owing to the fact that, on the one hand, it does not require a displacement sensor for its implementation and that, on the other hand, this implementation requires a simple software adaptation of the monitoring system of the vehicle.

Other features, objects and advantages of the invention will become apparent from the following detailed description, with reference to the appended drawings which show a preferred embodiment thereof as a nonlimiting example. In these drawings:

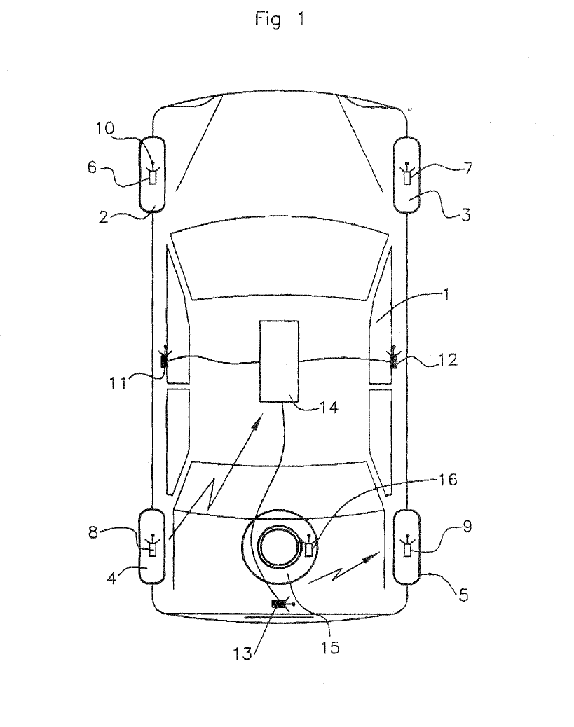

FIG. 1 is a schematic top view of a vehicle provided with a monitoring system designed to implement the discrimination method according to the invention; and

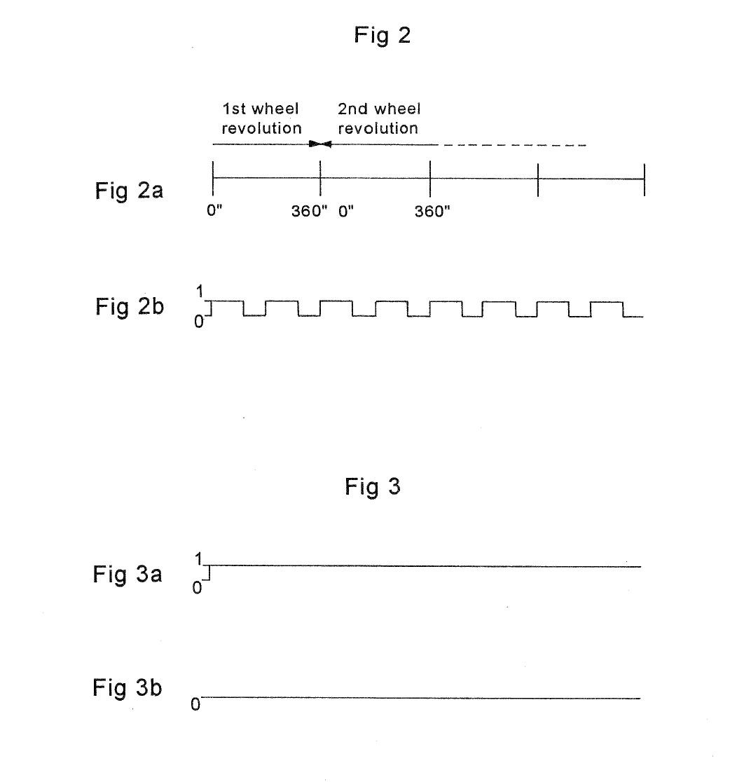

FIGS. 2a, 2b and 3a, 3b are four graphs intended to illustrate the method of discrimination according to the invention, and in particular show examples of the level of reception by a rotating wheel (FIG. 2b) and by a nonrotating wheel (FIGS. 3a and 3b).

The method of discrimination according to the invention is designed to carry out the “self-learning” function of a monitoring system such as that shown in FIG. 1, with which a vehicle 1 is fitted, said vehicle being provided with:
four wheels mounted on the axles of the vehicle 1 and consisting of two front wheels 2, 3 and two rear wheels 4, 5; and
a spare wheel 15, in the example placed in or under the trunk of the vehicle 1.

Such monitoring systems conventionally comprise, firstly, associated with each wheel 2-5, 15, an electronic module 6-9, 16 fastened for example to the rim of said wheel so as to be positioned inside the envelope of the tire.

Each of these electronic modules 6-9, 16 incorporates, for example, sensors dedicated to measuring parameters, such as the pressure and/or temperature of the tire, said sensors being connected to a microprocessor which possesses an identification code for said module and is connected to an RF (high frequency) transmitter connected to a high-frequency antenna such as 10.

The monitoring system also includes a centralized calculator or central processing unit 14 comprising a microprocessor and incorporating an RF receiver capable of receiving the signals transmitted by the electronic modules.

As is usual, such a monitoring system and in particular its central processing unit 14 are designed so as to inform the driver of any abnormal variation in the parameters measured by the sensors associated with the wheels 2-5.

This monitoring system also includes transmitting antennas 11-13 connected to the central processing unit 14, each being placed near a pair of left-hand wheels 2, 4, a pair of right-hand wheels 3, 5 or a pair of rear wheels 4, 5.

According to the exemplary embodiment shown in FIG. 1, these transmitting antennas 11-13 consist of antennas of a device usually known as the “hands-free access device” designed to allow access to the vehicle 1 and optionally to start the latter thanks to the identification of an electronic badge.

According to the provisions of such a hands-free access device, these antennas may, as shown in FIG. 1, be three in number and consist, respectively, of:
a left-hand antenna 11 positioned on the front-left door handle of the vehicle, designed to have a coverage area within which the left front wheel 2 and the left rear wheel 4 of the vehicle 1 lie;
a right-hand antenna 12 positioned on the front-right door handle of the vehicle, designed to have a coverage area within which the right front wheel 3 and the right rear wheel 5 of the vehicle 1 lie; and
a rear antenna 13 positioned on the handle of the trunk of the vehicle 1, designed to have a coverage area within which, on the one hand, the left rear wheel 4 and the right rear wheel 5 and, on the other hand, the spare wheel 15 of the vehicle 1 lie.

According to the invention, the central processing unit 14 is programmed to calculate the level of reception of the identification request signals transmitted via the antennas 11-13. To do this, the central processing unit knows how many messages have been transmitted by these antennas, and a counter (not shown) fitted into the electronic modules counts the number of messages actually received by the electronic modules. This number of messages received is transmitted to the central processing unit. The central processing unit therefore now has only to calculate, on the basis of this information, the level of reception. Of course, as variant, this calculation may be carried out directly by each of the electronic modules 6-9, 16. In this case, the number of messages transmitted by the antennas 11-13 is predetermined and all that is required of a counter fitted into the electronic modules is to count the number of messages actually received in order to automatically determine the level of reception.

With regard to each axle-mounted wheel 2-5, the rotation of the latter, and therefore the rotation of the associated electronic module 6-9, results in the appearance of angular nonreception zones in which said electronic module does not receive the signals transmitted by the antenna(s) having a coverage area within which the wheel 2-5 lies.

The existence of these nonreception zones is apparent from analyzing FIGS. 2a and 2b, which illustrate the results of measuring the reception, by an electronic module 7 mounted on a right front wheel 3 of a vehicle 1, of the electromagnetic signals transmitted by an antenna 12 mounted on the front-right door handle of this vehicle. For the purpose of this illustration, these figures show, respectively, in projection on a horizontal axis:
the path traveled by an electronic module mounted on a wheel (FIG. 2a); and
the corresponding zones of nonreception (level 0 of the signal shown in FIG. 2b) by this electronic module of the electromagnetic signals transmitted by the antenna.

It is clearly apparent from these figures that the electronic module forming the subject of the test carried out lies in succession in nonreception zones and reception zones in which the signals transmitted by the antenna responsible for transmitting the identification request signals sent to said module are not received and received, respectively.

Since the level of reception represents an image of the percentage reception zones/nonreception zones ratio over one revolution of the wheel, the level of reception of the rotating wheels 2-5 will thus vary within a range of values from about 50% to 80%.

In contrast, as regards the spare wheel 15 or any nonrotating wheel, the level of reception is only dependent on the “fixed” position of the electronic module 16 relative to the transmitting antenna 13. In fact:
either the electronic module 16 lies in a favorable zone for reception, as illustrated in FIG. 3a, when the level of reception is then close to 100%, in practice greater than 90%;
or the electronic module 16 lies in a nonreception zone, as illustrated in FIG. 3b, when the level of reception is then close to 0%, in practice less than 10%.

Consequently, the method of discrimination according to the invention makes it possible, by calculating the level of reception, to carry out the “self-learning” function right from the first revolutions of the wheels of a vehicle 1, without requiring a running speed threshold.

1. Method of discriminating, while a vehicle (1) is being driven, between the rotating wheels (2-5) and the nonrotating wheels (15) of said vehicle, each wheel being fitted with an electronic module (6-9, 16) designed to transmit signals representative of operating parameters of the wheel (2-5, 15) to a central processing unit (14) mounted on the vehicle (1), said method consisting in transmitting signals, called identification request signals, to the electronic modules (6-9, 16) and in commanding, in response, the transmission, by each of said electronic modules, of a signal that includes a parameter for identifying each module to the central processing unit (14), and said method being characterized in that it consists, upon reception of the identification request signals by an electronic module (6-9, 16), in calculating the level of reception of said identification request signals and in declaring that the corresponding wheel is rotating if said level of reception is between 10% and 90%.
